(19) United States
(12) Patent Application Publication
(10) Pub. No.: US 2026/0202793 A1
(43) Pub. Date: Jul. 16, 2026

(54) PHOTOPOLYMER FILM, COMPOSITION FOR FORMING PHOTOPOLYMER FILM, HOLOGRAM RECORDING MEDIUM AND OPTICAL ELEMENT

(71) Applicant: LG CHEM, LTD., Seoul (KR)

(72) Inventors: Chulsuk HONG, Daejeon (KR); Hanna LEE, Daejeon (KR); Jinyoung HWANG, Daejeon (KR); Yeonhui YI, Daejeon (KR); Soonhwa JUNG, Daejeon (KR); Inkyu LEE, Daejeon (KR)

(73) Assignee: LG CHEM, LTD., Seoul (KR)

(21) Appl. No.: 18/877,824

(22) PCT Filed: Nov. 22, 2023
(86) PCT No.: PCT/KR2023/018901

§ 371 Date: Sep. 26, 2025

(30) Foreign Application Priority Data
Nov. 28, 2022 (KR) 10-2022-0161773
Nov. 28, 2022 (KR) 10-2022-0161774

(51) Int. Cl. G03H 1/02; C08J 5/18

(52) U.S. Cl. CPC G03H 1/0256; C08J 5/18; C08J 2301/12; G03H 2001/0264; G03H 2260/12

(57) ABSTRACT

The present disclosure relates to a photopolymer film comprising a substrate film and a recording layer, and having a maximum reduction rate of a predetermined band area in a graph derived from the results of photothermal infrared (PTIR) spectroscopic analysis in a thickness direction from one surface of the recording layer, a composition for forming such photopolymer film, a holographic recording medium and an optical element comprising the same.

### CROSS REFERENCE OF RELATED APPLICATION(S)

This application is a 35 U.S.C. § 371 National Phase Entry Application from PCT/KR2023/018901, filed on Nov. 22, 2023, which claims the benefit of Korean Patent Application No. 10-2022-0161773 filed on Nov. 28, 2022 and Korean Patent Application No. 10-2022-0161774 filed on Nov. 28, 2022 with the Korean Intellectual Property Office, the disclosures of which are incorporated herein by reference in their entirety. The present disclosure relates to a photopolymer film, a composition for forming the photopolymer film, a holographic recording medium and an optical element comprising the photopolymer film.

### TECHNICAL FIELD

### Background

A holographic recording medium records information by changing a refractive index in a holographic recording layer in the medium through an exposure process, reads the variation of refractive index in the medium thus recorded, and reproduces the information.

When a photopolymer (photosensitive resin) is used, the light interference pattern can be easily stored as a hologram by photopolymerization of the low molecular weight monomer. Therefore, the photopolymer can be used in various fields such as for optical lenses, mirrors, deflecting mirrors, filters, diffusing screens, diffraction elements, light guides, waveguides, holographic optical elements having projection screen and/or mask functions, media of optical memory systems and light diffusion plates, optical wavelength multiplexers, reflection type and transmission type color filters, and the like.

The photopolymer film can be produced by applying a composition containing a low-molecular-weight monomer and a photoinitiator to a substrate film, followed by thermal curing, and the photopolymer film produced by this method is composed of a substrate film and a recording layer on which recording progresses. The recording layer is irradiated with laser interference light to induce local photopolymerization of the monomer.

However, the photopolymer film produced by this method has poor adhesion between the substrate film and the recording layer, so the reliability may be reduced due to the influence of the external environment. Therefore, a lot of researches have been conducted to improve the adhesion, but the degree of improvement in physical properties resulting therefrom is insufficient.

### DETAILED DESCRIPTION OF THE INVENTION

### Technical Problem

It is an object of the present disclosure to provide a photopolymer film having an optimized recording efficiency while exhibiting excellent heat resistance and moist heat resistance reliability, along with improved adhesion between the substrate film and the recording layer.

It is another object of the present disclosure to provide a composition for forming the photopolymer film.

It is yet another object of the present disclosure to provide a holographic recording medium and an optical element comprising the photopolymer film.

### Technical Solution

Provided herein is a photopolymer film comprising a substrate film and a recording layer, wherein a graph derived from the results of photothermal infrared (PTIR) spectroscopic analysis in the thickness direction from one surface of the recording layer facing the substrate film satisfies the following Equation 1, in which a band area of the carbonyl group (C═O group) peak included in the recording layer is plotted on the Y-axis, and a distance in the thickness direction from one surface of the recording layer facing the substrate film is plotted on the X-axis.

Also provided herein is a composition for forming a photopolymer film, comprising a coating solution which includes a polymer matrix containing a siloxane polymer or a precursor thereof, a photoreactive monomer, and an erosion solvent, wherein the content of the erosion solvent is 25 wt. % or more and 70 wt. % or less with respect to 100 wt. % of the coating solution. Further provided herein is a holographic recording medium comprising the photopolymer film.

Further provided herein is an optical element comprising the photopolymer film.

Now, a photopolymer film, a composition for forming the photopolymer film, a holographic recording medium and an optical element comprising the same according to specific embodiments of the present disclosure will be described in more detail.

The term “hologram” as used herein means a medium (or media) on which optical information is recorded in an entire visible range and a near ultraviolet range (e.g., 300~800 nm) through an exposure process. Examples of the hologram may include all of visual holograms such as in-line (Gabor) holograms, off-axis holograms, full-aperture transfer holograms, white light transmission holograms (“rainbow holograms”), Denisyuk holograms, off-axis reflection holograms, edge-lit holograms or holographic stereograms.

The (meth)acrylate as used herein means one or both of acrylate and methacrylate.

Further, in this specification, the weight average molecular weight (Mw) and the number average molecular weight (Mn) refers to the molecular weight converted in terms of polystyrene (unit: Da (Dalton)) measured by gel permeation chromatography (GPC). In the process of determining the weight average molecular weight in terms of polystyrene measured by the GPC method, a detector such as a commonly known analysis apparatus and differential refractive index detector, and an analytical column can be used, and commonly applied conditions for temperature, solvent, and flow rate can be used. Specific examples of the measurement conditions may include a temperature of 30° C., chloroform solvent and a flow rate of 1 mL/min. In specific examples of the measurement conditions, a Waters PL-GPC220 instrument was used with a PLgel MIX-B column (length of 300 mm) from Polymer Laboratories, the evaluation temperature was 160° C., 1,2,4-trichlorobenzene was used as a solvent, and the flow rate was 1 mL/min. The sample was prepared at a concentration of 10 mg/10 mL, and then supplied in an amount of 200 μL. The values of Mw and Mn can be respectively determined using the calibration curve generated with polystyrene standards. Nine types of the polystyrene standards with respective molecular weights of 2,000/10,000/30,000/70,000/200,000/700,000/2,000,000/4,000,000/10,000,000 were used.

According to one embodiment of the present disclosure, there can be provided a photopolymer film comprising a substrate film and a recording layer, wherein a graph derived from the results of photothermal infrared (PTIR) spectroscopic analysis in the thickness direction from one surface of the recording layer facing the substrate film satisfies the following Equation 1, in which a band area of the carbonyl group (C═O group) peak included in the recording layer is plotted on the Y-axis, and a distance in the thickness direction from one surface of the recording layer facing the substrate film is plotted on the X-axis.

$$0.01 {μm}^{- 1} ≦ Maximum reduction rate of band area ≦ 0.095 {μm}^{- 1} \qquad [ Equation 1 ]$$

in Equation 1,
the maximum reduction rate of band area is the absolute value of the minimum value of the y value in the graph obtained by first differentiating the graph.

The present inventors have found that a photopolymer film comprising a substrate film and a recording layer, wherein a maximum reduction rate of band area according to Equation 1 is 0.010 μm⁻¹ or more, 0.020 μm⁻¹ or more, 0.030 μm⁻¹ or more, 0.040 μm⁻¹ or more, 0.050 μm⁻¹ or more, 0.060 μm⁻¹ or more, or 0.062 μm⁻¹ or more, and 0.095 μm⁻¹ or less, 0.090 μm⁻¹ or less, 0.085 μm⁻¹ or less, or 0.082 μm⁻¹ or less, has excellent adhesion between the substrate film and the recording layer, and exhibits excellent heat resistance and moist heat resistance reliability, and completed the present disclosure.

The photothermal infrared (PTIR) spectroscopic analysis can be measured in the thickness direction of the recording layer based on one surface of the recording layer facing the substrate film. At this time, the measurement interval may be 0.3 to 5 μm, 0.5 to 2 μm, or 1 μm.

For example, when the measurement interval is 1 μm, one surface of the recording layer becomes the reference (0 μm) so that first, the photothermal infrared spectroscopic analysis may be performed, second, the photothermal infrared spectroscopic analysis may be performed at a position 1 μm in the thickness direction for one surface of the recording layer, and third, the photothermal infrared spectroscopic analysis may be performed at a position 2 μm in the thickness direction for one surface of the recording layer. After that, the photothermal infrared spectroscopic analysis may be performed sequentially at 1 μm intervals in the thickness direction up to one surface of the optical film facing the recording layer.

In the graph derived by the photothermal infrared spectroscopic analysis, the X-axis is the distance in the thickness direction from one surface of the recording layer facing the substrate film, and means one surface (one face) of the recording layer facing the optical film if the X value is 0 μm. In addition, the result value may appear in the graph according to the measurement interval. For example, when the measurement interval of the photothermal infrared spectroscopic analysis is 1 μm, the result value may appear at 1 μm intervals along the X-axis in the graph.

Further, in the graph, the Y-axis is the band area of the carbonyl group (C═O group) peak included in the recording layer, and the carbonyl group (C═O group) peak may appear at about 1720 to 1725 cm⁻¹.

For example, when the photothermal infrared spectroscopic analysis is performed on the recording layer in the thickness direction, the value of the band area of the peak of the carbonyl group contained in the recording layer may appear as the Y value. For example, when the photoreactive monomer included in the recording layer includes an acrylate group, the band area of the carbonyl group (C═O group) peak of the acrylate group may appear as the value of the Y axis. That is, the graph derived from the results of the photothermal infrared spectroscopic analysis is a graph showing the band area value of the carbonyl group (C═O group) peak included in the recording layer, which is the Y value corresponding to the X value (distance in the thickness direction from one surface of the recording layer facing the substrate film).

On the other hand, FIG. 2 is a diagram schematically showing the movement of the carbonyl group (C═O group) peak as a result of photothermal infrared spectroscopic analysis in the thickness direction from one surface of the recording layer facing the substrate film, which can be confirmed that the movement occurs from the carbonyl group peak included in the red recording layer to the carbonyl group peak included in the blue substrate film. In addition, it can be confirmed that an erosion layer is further included between the recording layer and the substrate film, and as the erosion layer is formed, a movement typically appears between the red and blue carbonyl group (C═O group) peaks.

Further, the graph derived from the results of the photothermal infrared spectroscopic analysis can be fitted with the Boltzmann Sigmoid Function according to the following [Mathematical Formula 2].

$$y = \frac{{A}_{1} - {A}_{2}}{1 + {e}^{( x - {x}_{0} ) / dx}} + {A}_{2} \qquad [ Mathematical Formula 2 ]$$

in the Mathematical Formula 2,
A₁: Initial y value, the band area of carbonyl peak on one surface of the recording layer facing the substrate film
A₂: Final y value, the band area of carbonyl peak on one surface of the recording layer close to the substrate film
x₀: x value having a center y value, x value at the point where the carbonyl band area of the recording layer is (A₁+A₂)/₂.
dx: Time constant, reduction rate from A₁ to A₂.

After the data derived from the results of the photothermal infrared spectroscopic analysis is fitted with the Boltzmann sigmoid function, the absolute value of the minimum value of the y value in the graph obtained by first differentiating the graph fitted with the Boltzmann sigmoid function may be the maximum reduction rate of band area. That is, the maximum reduction rate of band area may be the absolute value of the minimum value of the slope in the graph analyzed by the photothermal infrared spectroscopy or in the graph that fits the graph analyzed by the photothermal infrared spectroscopy to the Boltzmann sigmoid function.

The photopolymer film according to the one embodiment may have a maximum reduction rate of band area of: 0.010 μm⁻¹ or more, 0.012 μm⁻¹ or more, 0.014 μm⁻¹ or more, 0.020 μm⁻¹ or more, 0.030 μm⁻¹ or more, 0.040 μm⁻¹ or more, 0.050 μm⁻¹ or more, 0.060 μm⁻¹ or more, or 0.062 μm⁻¹ or more, and 0.095 μm⁻¹ or less, 0.093 μm⁻¹ or less, 0.091 μm⁻¹ or less, 0.090 μm⁻¹ or less, 0.085 μm⁻¹ or less, or 0.082 μm⁻¹ or less. If the maximum reduction rate of band area is too small, the erosion layer described below is formed too thickly, so that the thickness of the recording layer where recording is actually performed becomes rather thinner, and thus may exhibit low recording efficiency, and if the maximum reduction rate of band area is too large, the erosion layer described below is not formed, so that the adhesion between the substrate film and the recording layer is reduced, and the heat resistance and moist resistance reliability may be reduced.

The photopolymer film according to the one embodiment may further include an erosion layer between the substrate film and the recording layer. For example, the erosion layer and the recording layer may be sequentially formed on the substrate film. In addition, it may also be considered as a coating layer including the erosion layer and the recording layer. That is, the photopolymer film may include a coating layer including the erosion layer and the recording layer.

When producing the photopolymer film, the composition of the coating solution can be adjusted to form an erosion layer on the substrate film. For example, the coating solution can include a polymer matrix containing a siloxane-based polymer or a precursor thereof, a photoreactive monomer, and an erosion solvent, etc., and when the coating solution is applied to the substrate film, the erosion solvent can dissolve at least a part of the substrate film so that the coating solution can penetrate.

Subsequently, when a drying process for forming a coating layer is performed, the polymer matrix containing the siloxane-based polymer may be cured or crosslinked to form an erosion layer, wherein the erosion layer may include a photoreactive monomer and/or a part of the substrate. In addition, the erosion layer formed of the polymer matrix containing the siloxane-based polymer that has penetrated the substrate film may be physically bonded to the substrate film.

Therefore, the erosion layer is formed by a method in which the erosion solvent included in the coating solution dissolves a part of the substrate film, the coating solution is penetrated, and the polymer matrix included in the penetrated coating solution is cured or crosslinked. Therefore, the erosion layer may include a partial component of the substrate film dissolved by the erosion solvent. Further, the polymer matrix and the substrate contained in the erosion layer may be physically bonded through a drying process.

On the other hand, a recording layer may be formed on the erosion layer, and the recording layer may include a polymer matrix containing a siloxane-based polymer, a photoreactive monomer, and the like.

As mentioned above, since the erosion layer is formed on the substrate film, the adhesion between the optical film and the recording layer can be greatly improved, and by adjusting the degree to which the erosion layer is formed, it is possible to minimize the decrease in recording efficiency of the photopolymer film while achieving excellent mechanical properties such as heat resistance and moist heat resistance reliability. The presence or absence of the erosion layer or the thickness of the erosion layer can be confirmed using the photothermal infrared spectroscopic analysis mentioned above.

When producing the photopolymer film, the composition of the coating solution can be adjusted to form an erosion layer on the substrate film. For example, the coating solution may include a polymer matrix containing a siloxane-based polymer or a precursor thereof, a photoreactive monomer, a solvent, and the like, whereby the recording layer can include a polymer matrix containing a siloxane-based polymer and a photoreactive monomer.

In addition, the weight ratio between the photoreactive monomer and the polymer matrix containing a siloxane-based polymer can be controlled to form the erosion layer. For example, when the weight ratio between the photoreactive monomer and the polymer matrix containing the siloxane-based polymer is 45:55 to 90:10, 45:55 to 85:15, 45:55 to 80:20, 45:55 to 75:25, 45:55 to 72:28, 48:52 to 72:28, an erosion layer can be formed between the substrate film and the recording layer. If the amount of the photoreactive monomer is too small relative to the polymer matrix containing the siloxane-based polymer, the erosion layer may not be formed, and if the amount of the photoreactive monomer is too large relative to the polymer matrix containing a siloxane-based polymer, the thickness of the recording layer may become thinner, so that the recording efficiency may be lowered.

When the coating solution is applied onto the substrate film, the photoreactive monomer and the solvent can dissolve and penetrate at least a part of the substrate film. After that, when a drying process for forming a coating layer is performed, the polymer matrix containing a siloxane-based polymer and the photoreactive monomer can be cured or crosslinked to form an erosion layer. Further, the photoreactive monomer that has penetrated the substrate film can be physically or chemically bonded to the substrate film.

Therefore, the erosion layer may include a photoreactive monomer, and the erosion layer may be physically or chemically bonded to the substrate film. For example, the physical bonding of the erosion layer and the substrate film may be achieved because the photoreactive monomer included in the erosion layer is physically bonded to the substrate film. Further, the coating layer may include a polymer matrix including a siloxane-based polymer and a photoreactive monomer.

On the other hand, a recording layer may be formed on the erosion layer, and the recording layer may include a polymer matrix containing a siloxane-based polymer, a photoreactive monomer, and the like.

As mentioned above, the erosion layer is formed on the substrate film, so that the adhesion between the optical film and the recording layer can be greatly improved, and by adjusting the degree to which the erosion layer is formed, it is possible to minimize the decrease in recording efficiency of the photopolymer film while achieving excellent mechanical properties such as heat resistance and moist heat resistance reliability. The presence or absence of an erosion layer or the thickness of the erosion layer can be confirmed using the photothermal infrared spectroscopic analysis mentioned above.

The erosion layer may have a thickness of: 1.0 μm or more, 1.5 μm or more, 2.0 μm or more, 2.3 μm or more, or 2.5 μm or more, and 10.0 μm or less, 9.0 μm or less, 8.0 μm or less, 7.0 μm or less, 6.0 μm or less, 5.5 μm or less, 5.0 μm or less, or 4.5 μm or less. If the thickness of the erosion layer is too thin, the adhesion between the substrate film and the recording layer may be reduced, and the heat resistance and moist resistance reliability may be degraded. If the thickness of the erosion layer becomes too thick, the thickness of the recording layer where recording is actually performed may become rather thinner, thereby exhibiting low recording efficiency.

The recording layer may have a thickness of 3.0 μm or more, 3.5 μm or more, or 4.0 um or more, and 8.0 μm or less, 7.0 μm or less, 6.8 μm or less, or 6.7 μm or less. If the thickness of the recording layer is too thin, it may exhibit low recording efficiency, and if the thickness of the above recording layer is too thick, the thickness of the erosion layer may become thinner and thus, the adhesion between the substrate film and the recording layer may be reduced.

The coating layer may have a thickness of 5.0 μm or more, 5.5 μm or more, 6.0 μm or more, and 20.0 μm or less, 15.0 μm or less, or 10.0 μm or less.

The photopolymer film may include a coating layer including an erosion layer and a recording layer, and the thickness ratio of the erosion layer to the coating layer may be 20.0% or more and 70.0% or less, for example, 21.0% or more, 22.0% or more, 23.0% or more, 24.0% or more, 25.0% or more, 30.0% or more, or 35.0% or more, and 70.0% or less, 68.0% or less, 66.0% or less, 65.0% or less, 63.0% or less, or 62.0% or less. If the thickness ratio is too low, the adhesion between the substrate film and the recording layer may be reduced, and the heat resistance and moist resistance reliability may be deteriorated, and if the thickness ratio is too large, the thickness of the recording layer where recording is actually performed may become thinner, thereby exhibiting low recording efficiency.

The substrate film according to the one embodiment is not particularly limited as long as it is a substrate film capable of forming the erosion layer, and for example, it may be a cellulose ester-based substrate film, a polyester-based substrate film, a poly(meth)acrylate-based substrate film, a polycarbonate-based substrate film, a cycloolefin-based (COP)-based substrate film, or an acryl-based substrate film.

Further, the substrate film may be a triacetyl cellulose (TAC)-based film, a polyethylene terephthalate (PET)-based substrate film, a polymethyl methacrylate (PMMA)-based substrate film, a cycloolefin (COP)-based substrate film, or an acryl-based substrate film.

The thickness of the substrate film may be 20 μm or more, 30 μm or more, 40 μm or more, and 500 μm or less, 300 μm or less, 100 μm or less, 80 μm or less, or 60 μm or less. The substrate film may satisfy the above-mentioned thickness and thus exhibit excellent mechanical properties, water resistance, low moisture permeability, and the like.

The photopolymer film may be used for hologram recording purposes.

According to another embodiment of the present disclosure, there can be provided a composition for forming a photopolymer film, comprising a coating solution which includes a polymer matrix containing a siloxane polymer or a precursor thereof, a photoreactive monomer, and an erosion solvent, wherein the content of the erosion solvent is 25 wt. % or more and 70 wt. % or less with respect to 100 wt. % of the coating solution.

As mentioned above, when the resin composition for forming a photopolymer film is applied onto the substrate film, the erosion solvent can dissolve and penetrate at least a part of the substrate film to form an erosion layer.

The coating solution may contain the erosion solvent in an amount of 25 wt. % or more and 70 wt. % or less, 28 wt. % or more and 68 wt. % or less, 30 wt. % or more and 65 wt. % or less, or 35 wt. % or more and 60 wt. % or less, with respect to 100 wt. % of the coating solution. The coating solution contains the erosion solvent in the above-mentioned amount and thus, can form an erosion layer.

Further, the corrosion solvent may be at least one selected from the group consisting of a ketone-based solvent, an ester-based solvent, a nitrogen-based compound solvent, a halogenated hydrocarbon-based solvent, and an aromatic hydrocarbon-based solvent. The ketone-based solvent may be methyl ethyl ketone, methyl isobutyl ketone, or acetone, and the ester-based solvent may be ethyl acetate, and the like.

Further, the resin composition for forming the photopolymer film may further include a non-corrosive solvent other than the above-mentioned corrosion solvent, and the non-corrosion solvent may be isopropyl alcohol, and the like.

The erosion solvent may be included in an amount of 35 wt. % or more and 90 wt. % or less, 40 wt. % or more and 85 wt. % or less, or 45 wt. % or more and 80 wt. % or less, with respect to 100 wt. % of the total solvent contained in the resin composition for forming the photopolymer film. If the amount of the erosion solvent is too small, the erosion layer is not formed or an excessively thin erosion layer is formed, so that the adhesion between the substrate film and the recording layer is lowered, and the heat resistance and moist resistance reliability may be decreased. If the amount of the erosion solvent is too large, the thickness of the recording layer where recording is actually performed may become rather thinner, thereby exhibiting low recording efficiency.

The resin composition for forming a photopolymer film according to the other embodiment may include a polymer matrix containing a siloxane-based polymer or a precursor thereof. The polymer matrix containing the siloxane-based polymer or a precursor thereof may serve as a support for a photopolymer film produced with the resin composition.

Further, the polymer matrix containing the siloxane polymer or a precursor thereof has a relatively low refractive index (e.g., n=1.40 to 1.55), and can therefore play a role in enhancing the refractive index modulation of the photopolymer film. Further, the polymer matrix is a polyol-based matrix and contains a siloxane-based polymer, and when a catalyst, such as a Pt-based catalyst, is introduced, high-speed crosslinking of the matrix is possible even at room temperature.

Further, the siloxane polymer can include one or more silane functional groups (Si—H). Further, the siloxane polymer can include a repeating unit of the following Chemical Formula 1 or a repeating unit of the following Chemical Formula 2.

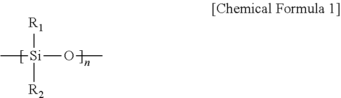

wherein, in each of the repeating units of the Chemical Formula 1, R₁ to R₂ may be the same or different from each other, and are hydrogen, halogen, or an alkyl group having 1 to 10 carbon atoms,
n is the repeating number of the repeating unit, 1 to 10,000,
in at least one of the repeating units, R₁ may be an alkyl group having 1 to 10 carbon atoms, and R₂ may be hydrogen.

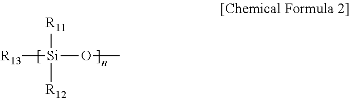

wherein, in each of the repeating units of the Chemical Formula 2, R₁₁ to R₁₃ may be the same or different from each other, and are hydrogen, halogen, or an alkyl group having 1 to 10 carbon atoms,
n is the repeating number of the repeating unit, 1 to 10,000,
in at least one repeating unit of the repeating units, R₁₁ and R₁₃ are an alkyl group having 1 to 10 carbon atoms, and R₁₂ is hydrogen, or
R₁₁ and R₁₂ are alkyl groups having 1 to 10 carbon atoms, and R₁₃ is hydrogen.

The number average molecular weight (measured by GPC) of the siloxane-based polymer may be 200 to 4,000 or 350 to 2,500.

Further, the polymer matrix may include a (meth)acrylic polyol containing two or more hydroxyl groups (—OH) in addition to a siloxane-based polymer containing one or more silane functional groups (Si—H). Consequently, the polymer matrix includes both a silane functional group (Si—H) and a hydroxyl group (—OH), wherein the molar ratio (SiH/OH) of the silane functional group (Si—H) to the hydroxyl group (OH) may be 0.80 or more and 3.5 or less, the lower limit may be, for example, 0.81 or more, 0.85 or more, 0.90 or more, 0.95 or more, 1.00 or more, or 1.05 or more, and the upper limit may be, for example, 3.4 or less, 3.3 or less, 3.2 or less, 3.05 or less, or 3.0 or less. Further, the type and content of the siloxane-based polymer and (meth)acrylic polyol in the polymer matrix can be controlled so as to satisfy the molar ratio (SiH/OH).

The resin composition for forming the photopolymer film may include the polymer matrix containing the siloxane-based polymer or its precursor in an amount of 25 wt. % or more and 35 wt. % or less, or 28 wt. % or more and 33 wt. % or less, with respect to 100 wt. % of the solid content of the resin composition. If the amount of the polymer matrix containing the siloxane-based polymer or its precursor is too large, an erosion layer may not be formed or an excessively thin erosion layer may be formed, thereby lowering the adhesion between the substrate film and the recording layer and reducing the heat resistance and moist resistance reliability. If the amount of the polymer matrix containing the siloxane-based polymer or its precursor is too small, the thickness of the recording layer on which recording is actually performed may actually may become thinner, thereby exhibiting low recording efficiency.

Further, the content of the erosion solvent relative to 100 wt. % of the polymer matrix containing the siloxane-based polymer or a precursor thereof may be 25 wt. % or more and 65 wt. % or less, 30 wt. % or more and 60 wt. % or less, or 35 wt. % or more and 55 wt. % or less. If the content of the erosion solvent relative to the polymer matrix containing the siloxane-based polymer or a precursor thereof is too low, an erosion layer may not be formed or an erosion layer may be formed too thinly, which may lead to the decrease of the adhesion between the substrate film and the recording layer and the deterioration of the heat resistance and moist resistance reliability. If the content of the erosion solvent is too large, the thickness of the recording layer where recording is actually performed may actually may become rather thinner, thereby exhibiting low recording efficiency.

The resin composition for forming a photopolymer film according to the other embodiment may further include a photoreactive monomer.

The photoreactive monomer may include a polyfunctional (meth)acrylate monomer or a monofunctional (meth)acrylate monomer.

An example of the photoreactive monomer may include (meth)acrylate-based α,β-unsaturated carboxylic acid derivatives, for example, (meth)acrylate, (meth)acrylamide, (meth)acrylonitrile, (meth)acrylic acid or the like, or a compound containing a vinyl group or a thiol group.

An example of the photoreactive monomer may include a polyfunctional (meth)acrylate monomer having a refractive index of 1.5 or more, 1.53 or more, or 1.5 to 1.7. The polyfunctional (meth)acrylate monomer having a refractive index of 1.5 or more, or 1.53 or more, or 1.5 to 1.7 may include a halogen atom (bromine, iodine, etc.), sulfur(S), phosphorus (P), or an aromatic ring.

More specific examples of the polyfunctional (meth)acrylate monomer having a refractive index of 1.5 or more include bisphenol A modified diacrylate type, fluorene acrylate series (HR6022, etc. manufactured by Miwon Specialty Chemical Co., Ltd.), bisphenol fluorene epoxy acrylate series (HR6100, HR6060, HR6042, etc. manufactured by Miwon Specialty Chemical Co., Ltd.), halogenated epoxy acrylate series (HR1139, HR3362, etc. manufactured by Miwon Specialty Chemical Co., Ltd.).

Another example of the photoreactive monomer may include a monofunctional (meth)acrylate monomer. The monofunctional (meth)acrylate monomer can contain an ether bond and a fluorene functional group in the molecule. Specific examples of such monofunctional (meth)acrylate monomer include phenoxy benzyl (meth)acrylate, o-phenylphenol ethylene oxide (meth)acrylate, benzyl (meth)acrylate, 2-(phenylthio)ethyl (meth)acrylate, biphenylmethyl (meth)acrylate, or the like.

Meanwhile, the photoreactive monomer may have a weight average molecular weight of 50 g/mol to 1000 g/mol, or 200 g/mol to 600 g/mol. The weight average molecular weight refers to a weight average molecular weight converted in terms of polystyrene measured by a GPC method.

The photopolymer composition for forming the photopolymer film may contain the photoreactive monomer in an amount of 6 wt. % or more and 30 wt. % or less, 8 wt. % or more and 25 wt. % or less, or 10 wt. % or more and 20 wt. % or less, with respect to 100 wt. % of the solid content of the composition. If the amount of the photoreactive monomer is too small, the erosion layer is not formed or an excessively thin erosion layer is formed, so that the adhesion between the substrate film and the recording layer is reduced, and the heat resistance and moisture resistance reliability may be reduced. If the amount of the photoreactive monomer is too large, the thickness of the recording layer on which recording is actually performed may actually may become thinner, thereby exhibiting low recording efficiency.

Further, the resin composition for forming the photopolymer film may contain 50 to 300 parts by weight of the photoreactive monomer base on 100 parts by weight of the polymer matrix containing the siloxane-based polymer, for example, the lower limit may be 50 parts by weight or more, 55 parts by weight or more, or 60 parts by weight or more, and the upper limit may be 300 parts by weight or less, 290 parts by weight or less, 285 parts by weight or less, or 280 parts by weight or less.

Further, the content of the erosion solvent relative to 100 wt. % of the photoreactive monomer may be 25 wt. % or more and 65 wt. % or less, 30 wt. % or more and 60 wt. % or less, or 35 wt. % or more and 55 wt. % or less. If the content of the erosion solvent relative to the photoreactive monomer is too low, the erosion layer may not be formed or an excessively thin erosion layer may be formed, thereby lowering the adhesion between the substrate film and the recording layer, and reducing the heat resistance and moisture resistance reliability. If the content of the erosion solvent is too large, the thickness of the recording layer on which recording is actually performed may actually become thinner, thereby exhibiting low recording efficiency.

The resin composition for forming a photopolymer film according to the other embodiments may include a photoinitiator. The photoinitiator is a compound which is activated by light or actinic radiation and initiates polymerization of a compound containing a photoreactive functional group such as the photoreactive monomer.

As the photoinitiator, commonly known photoinitiators can be used without particular limitation, but specific examples thereof include a photoradical polymerization initiator, a photocationic polymerization initiator, or a photoanionic polymerization initiator.

Specific examples of the photoradical polymerization initiator include imidazole derivatives, bisimidazole derivatives, N-aryl glycine derivatives, organic azide compounds, titanocene, aluminate complex, organic peroxide, N-alkoxypyridinium salts, thioxanthone derivatives, amine derivatives or the like. More specifically, examples of the photoradical polymerization initiator include 1,3-di(t-butyldioxycarbonyl)benzophenone, 3,3′,4,4″-tetrakis(t-butyldioxycarbonyl)benzophenone, 3-phenyl-5-isoxazolone, 2-mercapto benzimidazole, bis(2,4,5-triphenyl) imidazole, 2,2-dimethoxy-1,2-diphenylethane-1-one (product name: Irgacure 651/manufacturer: BASF), 1-hydroxy-cyclohexyl-phenyl-ketone (product name: Irgacure 184/manufacturer: BASF), 2-benzyl-2-dimethylamino-1-(4-morpholinophenyl)-butanone-1 (product name: Irgacure 369/manufacturer: BASF), and bis(η5-2,4-cyclopentadiene-1-yl)-bis(2,6-difluoro-3-(1H-pyrrole-1-yl)-phenyl) titanium (product name: Irgacure 784/manufacturer: BASF), Ebecryl P-115 μmanufacturer: SK entis), or the like.

The photocationic polymerization initiator may include a diazonium salt, a sulfonium salt, or an iodonium salt, and examples thereof include sulfonic acid esters, imidosulfonates, dialkyl-4-hydroxysulfonium salts, arylsulfonic acid-p-nitrobenzyl esters, silanol-aluminum complexes, (n6-benzene) (n5-cyclopentadienyl) iron (II), or the like. In addition, benzoin tosylate, 2,5-dinitrobenzyltosylate, N-tosylphthalic acid imide, or the like can be mentioned. More specific examples of the photocationic polymerization initiator include commercially available products such as Cyracure UVI-6970, Cyracure UVI-6974 and Cyracure UVI-6990 (manufacturer: Dow Chemical Co. in USA), Irgacure 264 and Irgacure 250 μmanufacturer: BASF) or CIT-1682 μmanufacturer: Nippon Soda).

The photoanionic polymerization initiator may be borate salt, for example, butyryl chlorine butyl triphenyl borate, or the like. More specific examples of the photoanionic polymerization initiator include commercially available products such as Borate V (manufacturer: Spectra Group).

In addition, the photopolymer composition may include monomolecular (type I) initiator or bimolecular (type II) initiator. The (type I) system for free radical photopolymerization may include, for example, an aromatic ketone compounds in combination with a tertiary amine, such as benzophenone, alkylbenzophenone, 4,4′-bis(dimethylamino)benzophenone (Michler's ketone), anthrone and halogenated benzophenone or a mixture of these types. The bimolecular (type II) initiator may include benzoin and derivatives thereof, benzyl ketal, acylphosphine oxide, for example, 2,4,6-trimethylbenzoyldiphenylphosphine oxide, bisacylophosphine oxide, phenylglyoxyl ester, camphorquinone, alpha-aminoalkylphenone, alpha, alpha-dialkoxyacetophenone, 1-[4-(phenylthio)phenyl] octane-1,2-dione 2-(O-benzoyloxime), alpha-hydroxyalkylphenone, and the like.

Further, the resin composition for forming a photopolymer film according to the other embodiment may further include a fluorine-based compound. Since the fluorine-based compound has stability with almost no reactivity and has low refractive characteristics, it can further lower the refractive index of the polymer matrix when added to the resin composition, thereby maximizing the refractive index modulation with the monomer. The fluorine-based compound may function as a plasticizer.

The fluorine-based compound may include at least one functional group selected from the group consisting of an ether group, an ester group, and an amide group, and at least two difluoromethylene groups. More specifically, the fluorine-based compound may have a structure represented by the following Chemical Formula 4 in which a functional group including an ether group is bonded to both ends of a central functional group containing a direct bond or an ether bond between two difluoromethylene groups.

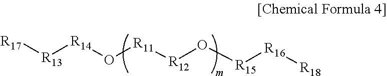

wherein, in Chemical Formula 4,
R₁₁ and R₁₂ are each independently a difluoromethylene group, R₁₃ and R₁₆ are each independently a methylene group, R₁₄ and R₁₅ are each independently a difluoromethylene group, R₁₇ and R₁₈ are each independently a polyalkylene oxide group, m is an integer of 1 or more, or 1 to 10, or 1 to 3.

Preferably, in the Chemical Formula 4, R₁₁ and R₁₂ are each independently a difluoromethylene group, R₁₃ and R₁₆ are each independently a methylene group, R₁₄ and R₁₅ are each independently a difluoromethylene group, R₁₇ and R₁₈ are each independently a 2-methoxyethoxymethoxy group, and m is an integer of 2.

The fluorine-based compound may have a refractive index of less than 1.45, or 1.3 or more and less than 1.45. As mentioned above, since the photoreactive monomer has a refractive index of 1.5 or more, the fluorine-based compound can further lower the refractive index of the polymer matrix through a lower refractive index than that of the photoreactive monomer, thereby maximizing the refractive index modulation with the monomer.

Further, the resin composition for forming the photopolymer film may contain 20 to 200 parts by weight of the fluorine compound with respect to 100 parts by weight of the polymer matrix containing the siloxane polymer, for example, the lower limit may be 20 parts by weight or more, 25 parts by weight or more, 30 parts by weight or more, 35 parts by weight or more, or 40 parts by weight or more, and the upper limit may be 200 parts by weight or less, 190 parts by weight or less, or 180 parts by weight or less.

Further, the content of the fluorine-based compound may be 30 to 150 parts by weight, or 50 to 110 parts by weight, with respect to 100 parts by weight of the photoreactive monomer, and the refractive index of the polymer matrix may be 1.46 to 1.53. If the content of the fluorine-based compound is excessively reduced relative to 100 parts by weight of the photoreactive monomer, the refractive index modulation value after recording may be lowered due to a lack of low-refractive index components, and if the content of the fluorine-based compound is excessively increased relative to 100 parts by weight of the photoreactive monomer, there is a problem that a haze occurs due to compatibility issues with other components, or some fluorine-based compounds may be eluted to the surface of the recording layer.

The weight average molecular weight (measured by GPC) of the fluorine-based compound may be 300 or more, or 300 to 1000. The specific method of measuring the weight average molecular weight is as mentioned above.

The polymer matrix containing the siloxane-based polymer or a precursor thereof may further include the fluorine-based compound.

On the other hand, the resin composition for forming the photopolymer film may further include a photosensitizing dye. The photosensitizing dye serves as a sensitizing pigment to sensitize the photoinitiator. More specifically, the photosensitizing dye can be stimulated by the light irradiated on the photopolymer composition and can also serve as an initiator to initiate polymerization of the monomer and the crosslinking monomer. The photosensitizing dye may be contained in an amount of 0.01 wt. % to 30 wt. % t, or 0.05 wt. % to 0.50 wt. % with respect to 100 wt. % of the resin composition.

Examples of the photosensitizing dye are not particularly limited, and various compounds commonly known in the art can be used. Specific examples of the photosensitizing dye include sulfonium derivative of ceramidonine, new methylene blue, thioerythrosine triethylammonium, 6-acetylamino-2-methylceramidonin, eosin, erythrosine, rose bengal, thionine, basic yellow, Pinacyanol chloride, Rhodamine 6G, Gallocyanine, ethyl violet, Victoria blue R, Celestine blue, QuinaldineRed, Crystal Violet, Brilliant Green, Astrazon orange G, Darrow Red, Pyronin Y, Basic Red 29, pyrylium iodide, Safranin O, Cyanine, Methylene Blue, Azure A, or a combination of two or more thereof.

The polymer matrix containing the siloxane polymer or its precursor may further include the dye.

The resin composition for forming the photopolymer film can further include other additives, catalysts, or the like. For example, the resin composition can include a catalyst which is commonly known for promoting polymerization of the polymer matrix or the photoreactive monomer. Examples of the catalyst include Karstedt's catalyst, rhodium-based catalysts, iridium-based catalysts, rhenium-based catalysts, molybdenum-based catalysts, iron-based catalysts, nickel-based catalysts, alkali metal and alkaline earth metal catalysts. As the non-metal catalyst, a Lewis acids-based catalyst, a carbene-based catalyst, or the like can be used.

Examples of the other additives include a defoaming agent or a phosphate-based plasticizer, and the defoaming agent can be a silicone-based reactive additive, for example, Tego Rad 2500. Examples of the plasticizer include phosphate compounds such as tributyl phosphate, and the plasticizer can be added in a weight ratio of 1:5 to 5:1 together with the fluorine-based compound. The plasticizer can have a refractive index of less than 1.5 and a molecular weight of 700 or less.

The components contained in the resin composition for forming the photopolymer are uniformly mixed, and then dried and cured at a temperature of 30° C. or more and 180° C. or less, 40° C. or more and 100° C. or less, or 50° C. or more and 90° C. or less to produce a photopolymer film according to the one embodiment.

For example, the resin composition may be prepared by first homogeneously mixing the components forming a polymer matrix or its precursor, and then crosslinking the matrix into a liquid state at room temperature using a Pt-based catalyst. The photopolymerizable monomer and initiator may be added later to prepare a resin composition for forming a final photopolymer film.

For mixing the components contained in the resin composition, a commonly known mixer, stirrer, mixer or the like can be used without any particular limitation, and the temperature during the mixing process may be 0° C. or more and 100° C. or less, 10° C. or more and 80° C. or less, or 20° C. or more and 60° C. or less. The temperature of the drying may vary depending on the composition of the photopolymer, and may be accelerated, for example, by heating to a temperature of 30° C. to 180° C. During the drying, the resin composition may be injected into or coated onto a predetermined substrate film or mold.

The method and apparatus commonly used for coating the resin composition onto the substrate film can be used without any particular limitation. For example, a bar coating method, such as one using a Mayer bar or the like, a gravure coating method, a 2-roll reverse coating method, a vacuum slot die coating method, a 2-roll coating method, or the like can be used.

According to yet another embodiment of the disclosure, a holographic recording medium comprising the photopolymer film can be provided.

As mentioned above, the photopolymer film has high adhesion between the recording layer and the substrate film, and optimizes recording efficiency while providing excellent heat resistance and moist heat resistance reliability. Thus, a holographic recording medium including the photopolymer film can also optimizes recording efficiency while providing excellent heat resistance and moist heat resistance reliability.

The photopolymer film can be prepared into a hologram for optical applications in the entire visible range and a near ultraviolet range (300 to 800 nm) through a predetermined exposure process.

As a method of recording a visual hologram on a holographic recording medium including the photopolymer film, commonly known methods can be used without particular limitations.

For example, a visual hologram can be recorded through a method of selectively polymerizing photoreactive monomers contained in the photopolymer film using a coherent laser.

According to another embodiment of the disclosure, an optical element comprising the photopolymer film may be provided. Further, the optical element may include a holographic recording medium comprising the photopolymer film.

Specific examples of the optical elements include optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

An example of an optical element comprising the photopolymer film may include a hologram display device. The hologram display device includes a light source unit, an input unit, an optical system, and a display unit. The light source unit is a portion that irradiates a laser beam used for providing, recording, and reproducing three-dimensional image information of an object in the input unit and the display unit. Further, the input unit is a portion that previously inputs three-dimensional image information of an object to be recorded on the display unit, specifically, a portion in which three-dimensional information of an object such as the intensity and phase of light for each space can be inputted into an electrically addressed liquid crystal SLM, wherein an input beam may be used. The optical system may include a mirror, a polarizer, a beam splitter, a beam shutter, a lens, and the like. The optical system can be distributed into an input beam for sending a laser beam emitted from the light source unit to the input unit, a recording beam for sending the laser beam to the display unit, a reference beam, an erasing beam, a reading beam, and the like.

The display unit can receive three-dimensional image information of an object from an input unit, record it on a hologram plate comprising an optically addressed SLM, and reproduce the three-dimensional image of the object. At this time, the three-dimensional image information of the object can be recorded via interference of the input beam and the reference beam. The three-dimensional image information of the object recorded on the hologram plate can be reproduced into a three-dimensional image by the diffraction pattern generated by the reading beam. The erasing beam can be used to quickly remove the formed diffraction pattern. On the other hand, the hologram plate can be moved between a position at which a three-dimensional image is inputted and a position at which a three-dimensional image is reproduced.

### Advantageous Effects

According to the present disclosure, a photopolymer film having an optimized recording efficiency while exhibiting excellent heat resistance and moist heat resistance reliability, along with improved adhesion between the substrate film and the recording layer, a composition for forming the same, a holographic recording medium and an optical element comprising the same can be provided.

### BRIEF DESCRIPTION OF THE DRAWINGS

FIG. 1 is a schematic diagram showing a cross section of a photopolymer film.

FIG. 2 is a schematic diagram showing the movement of a carbonyl group (C═O group) peak as a result of photothermal infrared spectroscopic analysis in the thickness direction from one surface of a recording layer of a photopolymer film.

FIG. 3 is a graph showing the results of photothermal infrared spectroscopic analysis of Examples and Comparative Examples fitted with a Boltzmann sigmoid function.

FIG. 4 is a graph showing the primary differentiation of the photothermal infrared spectroscopic analysis graph.

FIG. 5 is a photograph of a cross section of the photopolymer film of Example 1 taken with an SEM.

FIG. 6 is a photograph of a cross section of the photopolymer film of Example 2 taken with an SEM.

FIG. 7 is a photograph of a cross section of the photopolymer film of Comparative Example 1 taken with an SEM.

FIG. 8 shows photographs showing the results of an adhesion evaluation of Examples and Comparative Examples.

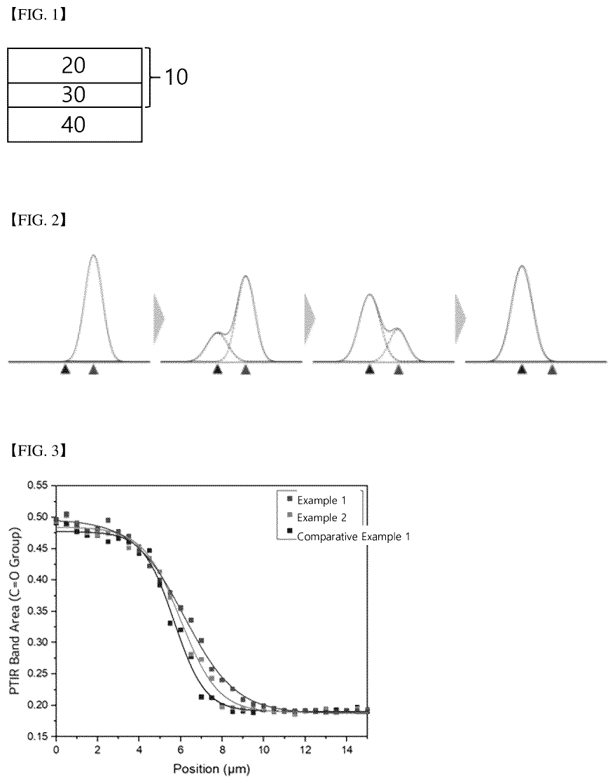

### DETAILED DESCRIPTION OF THE EMBODIMENTS

Hereinafter, exemplary embodiments of the present disclosure will be described in more detail with reference to the following examples. However, the following examples are provided for illustrative purposes only, and the scope of the present disclosure is not intended to be limited thereby.

### Preparation Example

### Preparation Example 1: Preparation of (meth)acrylic-Based Polyol

132 g of butyl acrylate, 420 g of ethyl acrylate, and 48 g of hydroxybutyl acrylate were added to a 2 L jacketed reactor, and diluted with 1200 g of ethyl acetate. The reaction temperature was set to 60~70° C., and the mixture was stirred for about 30 minutes to 1 hour. 0.42 g of n-dodecyl mercaptan (n-DDM) was further added, and stirring was further performed for about 30 minutes. Then, 0.24 g of AIBN as a polymerization initiator was added, polymerization was carried out at the reaction temperature for 4 hours or more, and kept until the residual acrylate content became less than 1%. Thereby, a (meth)acrylate-based copolymer (weight average molecular weight of about 300,000, OH equivalent of about 1802 g/equivalent) in which the hydroxy group was located in the branched chain was prepared.

### Preparation Example 2: Preparation of Fluorine-Based Compound

20.51 g of 2,2′-{oxybis [(1,1,2,2-tetrafluoroethane-2,1-diyl)oxy]} bis(2,2-difluoroethan-1-ol) was added to a 1000 mL flask, and dissolved in 500 g of tetrahydrofuran, to which 4.40 g of sodium hydride (60% dispersion in mineral oil) was carefully added several times while stirring at 0° C. After stirring at 0° C. for 20 minutes, 12.50 mL of 2-methoxyethoxymethyl chloride was slowly added dropwise. When it was confirmed by 1H NMR that all the reactants were consumed, work-up using dichloromethane gave 29 g of a liquid product with a purity of 95% or more in a yield of 98%. The weight average molecular weight of the prepared fluorine-based compound was 586, and the refractive index measured with an Abbe refractometer was 1.361.

### Example and Comparative Example: Production of Photopolymer Film

### Example 1

2.5 g of (meth)acrylic-based polyol prepared in Preparation Example 1, 0.10 g of siloxane-based polymer containing a silane (Si—H) functional group (product name: Poly(methylhydrosiloxane), manufacturer: Sigma-Aldrich, Mn=~ 390), 1.00 g of fluorine-based compound prepared in Preparation Example 2, 0.50 g of dye HNu-640 (Spectra), and 0.60 g of photoreactive monomer (high refractive index acrylate, refractive index 1.600, HR6042, Miwon Specialty Chemical) were mixed with the solvent while blocking light so that the solid content was 25% of 100 parts by weight of the total coating solution, and the ratio was set as shown in Table 1 below, and the mixture was stirred with a paste mixer for about 10 minutes. A Karstedt (Pt-based) catalyst was added for matrix crosslinking, and after crosslinking, a Borate V (Spectra Group) initiator was added to the coating solution, and then the mixture was further mixed for 5 minutes or more to prepare a coating solution. The coating solution was coated on a 40 μm-thick triacetyl cellulose (TAC) substrate film to a thickness of about 8 μm using a Mayer bar, and dried at 60° C. within 10 minutes to form a coating layer.

### Example 2

A photopolymer film was produced in the same manner as in Example 1, except that the solvents shown in Table 1 below were used.

### Example 3

1.70 g (solid content 0.52 g) of (meth)acrylic polyol prepared in Preparation Example 1, 0.09 g of siloxane-based polymer containing a silane (Si—H) functional group (product name: Poly(methylhydrosiloxane), manufacturer: Sigma-Aldrich, Mn=~ 390), 0.80 g of fluorine-based compound prepared in Preparation Example 2, 0.40 g of dye HNu-640 (Spectra), 0.56 g of photoreactive monomer (high refractive index acrylate, refractive index 1.600, HR6042, Miwon Specialty Chemical), 0.85 g of methyl ethyl ketone as a solvent, 0.75 g of methyl isobutyl ketone, 0.18 g of ethyl acetate, and 4.45 g of isopropyl alcohol were mixed with the solvent while blocking light, and the mixture was stirred with a paste mixer for about 10 minutes. 0.09 g of Karstedt (Pt-based) catalyst was added for matrix crosslinking, and after crosslinking, 0.15 g of Borate V (Spectra Group) initiator was added to the coating solution, and then the mixture was further mixed for 5 minutes or more to prepare a coating solution. The coating solution was coated on a 40 μm-thick triacetyl cellulose (TAC) substrate film to a thickness of about 8 μm using a Mayer bar, and dried at 60° C. within 10 minutes to form a coating layer. At this time, the coating solution was prepared so that the weight ratio of the photoreactive monomer and the polymer matrix in the total mass of the coating solution was 48:52.

Meanwhile, the content of ethyl acetate in Table 2 below corresponds to the sum of the content of the solvent (ethyl acetate) added alone to the paste mixer and the content of the solvent (ethyl acetate) contained in the ‘(meth)acrylic polyol prepared in Preparation Example 1’.

### Examples 4 to 8

A photopolymer film was produced in the same manner as in Example 3, except that polyol, siloxane-based polymer, photoreactive monomer, fluorine compound, dye, initiator, catalyst, methyl ethyl ketone, methyl isobutyl ketone, ethyl acetate, and isopropyl alcohol were used in the contents shown Table 2 below.

### Comparative Example 1

A photopolymer film was produced in the same manner as in Example 1, except that the solvents shown in Table 1 below were used.

### Comparative Examples 2 and 3

A photopolymer film was produced in the same manner as in Example 3, except that polyol, siloxane-based polymer, photoreactive monomer, fluorine-based compound, dye, initiator, catalyst, methyl ethyl ketone, methyl isobutyl ketone, ethyl acetate, and isopropyl alcohol were used in the contents shown Table 2 below.

TABLE 1

| | | Example | Example | Comparative |
|---|---|---|---|---|
| Unit: wt. % | | 1 | 2 | Example 1 |
| Erosion | Methyl ethyl ketone | 32.6 | 10.4 | 6.5 |
| solvent | Methyl isobutyl ketone | 12.8 | 11.2 | 3.5 |
| | Ethyl acetate | 13.6 | 13.6 | 13.6 |
| Non-erosion | Isopropyl alcohol | 15.0 | 38.9 | 50.5 |
| solvent | Others (solvent | 0.9 | 0.9 | 0.9 |
| | contained | | | |
| | in catalyst) | | | |

TABLE 2

| | | | | | | | Comparative | Comparative |
|---|---|---|---|---|---|---|---|---|
| | Example | Example | Example | Example | Example | \|Example | Example | Example |
| (Unit: g) | 3 | 4 | 5 | 6 | 7 | 8 | 2 | 3 |
| Polyol (solids) | 0.52 | 0.43 | 0.35 | 0.28 | 0.30 | 0.55 | 0.62 | 0.25 |
| Siloxane-based polymer | 0.09 | 0.07 | 0.06 | 0.05 | 0.05 | 0.10 | 0.10 | 0.04 |
| Photoreactive monomer | 0.56 | 0.66 | 0.75 | 0.83 | 0.82 | 0.53 | 0.45 | 0.87 |
| Fluorine-based compound | 0.80 | 0.80 | 0.80 | 0.80 | 0.80 | 0.80 | 0.80 | 0.80 |
| Dye | 0.40 | 0.40 | 0.40 | 0.40 | 0.40 | 0.40 | 0.40 | 0.40 |
| Initiator | 0.15 | 0.15 | 0.15 | 0.15 | 0.15 | 0.15 | 0.15 | 0.15 |
| Catalyst | 0.09 | 0.09 | 0.09 | 0.09 | 0.09 | 0.09 | 0.09 | 0.09 |
| Methyl ethyl ketone | 0.85 | 0.85 | 0.85 | 0.85 | 0.85 | 0.85 | 0.85 | 0.85 |
| Methyl isobutyl ketone | 0.75 | 0.75 | 0.75 | 0.75 | 0.75 | 0.75 | 0.75 | 0.75 |
| Ethyl acetate | 1.36 | 1.36 | 1.36 | 1.36 | 1.36 | 1.36 | 1.36 | 1.36 |
| Isopropyl alcohol | 4.45 | 4.45 | 4.45 | 4.45 | 4.45 | 4.45 | 4.45 | 4.45 |
| Weight ratio of photoreactive | 48:52 | 57:43 | 65:35 | 72:28 | 70:30 | 45:55 | 38:62 | 75:25 |
| monomer and polymer matrix | | | | | | | | |

### Evaluation

### 1. Measurement of Maximum Reduction Rate of Band Area in Photothermal Infrared (PTIR) Spectroscopic Analysis Graph

Photothermal infrared (PTIR) spectroscopic analysis was performed at 1 μm intervals in the thickness direction from the recording layer surface of the photopolymer film of the Examples and Comparative Examples (specifically, the surface of the recording layer facing the acrylic-based substrate), and the analysis conditions for photothermal infrared spectroscopic analysis are as follows.

### <Photothermal Infrared Spectroscopic Analysis Conditions>

Apparatus: mIRage (Photothermal Spectroscopy Corp.)
Light source: Tunable pulsed mid-IR Quantum Cascade Laser (1800~800 cm⁻¹), probe laser (532 nm)
Spectral resolution: spectral resolution 1 cm⁻¹, spatial resolution 500 nm
Microscope mode: Reflection mode
Detector: Avalanche photodiode detector

After that, the photothermal infrared spectroscopic analysis results analyzed at 1 μm intervals in the thickness direction were fitted with the Boltzmann Sigmoid Function according to the following [Mathematical Formula 2]. At this time, FIG. 3 is a graph showing the results of the photothermal infrared spectroscopy analysis fitted with a Boltzmann Sigmoid Function.

$$y = \frac{{A}_{1} - {A}_{2}}{1 + {e}^{( x - {x}_{0} ) / dx}} + {A}_{2} \qquad [ Mathematical Formula 2 ]$$

in the Mathematical Formula 2,

A₁: Initial y value, the band area of carbonyl peak on one surface of the recording layer facing the substrate film

A₂: Final y value, the band area of carbonyl peak on one surface of the recording layer close to the substrate film
x₀: x value having a center y value, x value at the point where the carbonyl band area of the recording layer is (A₁+A₂)/₂.
dx: Time constant, reduction rate from A₁ to A₂.

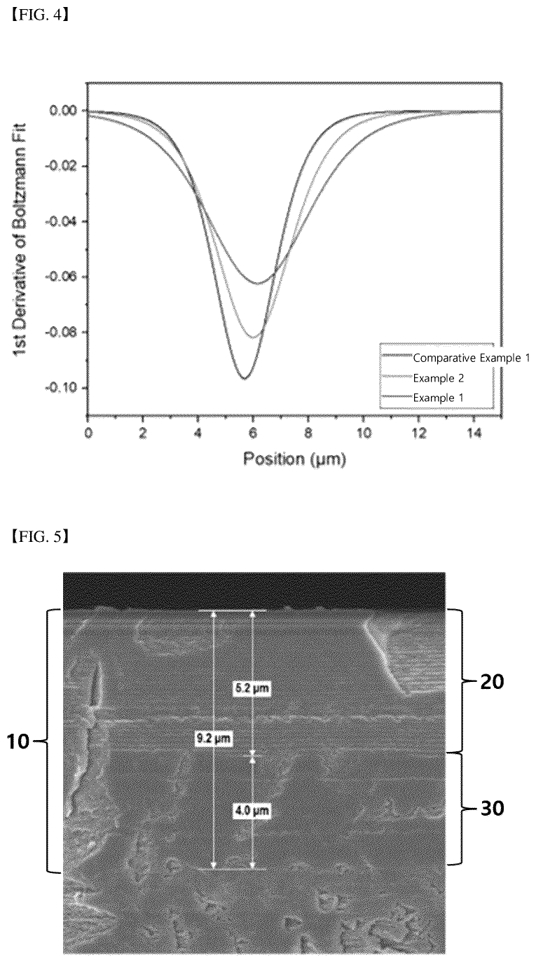

After that, the absolute value of the minimum value of the y value in the graph of the primary differentiation of the graph fitted with the Boltzmann sigmoid function, i.e., the maximum reduction rate of band area, was shown in Table 3 below. At this time, FIG. 4 is a graph showing the primary differentiation of the photothermal infrared spectroscopic analysis graph. Further, in Table 3, if the maximum reduction rate of band area was not measured, it was indicated as ‘-’

### 2. Measurement of the Thickness of the Recording Layer and the Erosion Layer

The cross sections of the photopolymer films of the Examples and Comparative Examples were analyzed using a scanning electron microscope (SEM) to measure the thicknesses of the recording layer and the erosion layer. In addition, the ratio of the thickness of the erosion layer to the total thickness of the coating layer was calculated, and the results are shown in Table 3 below.

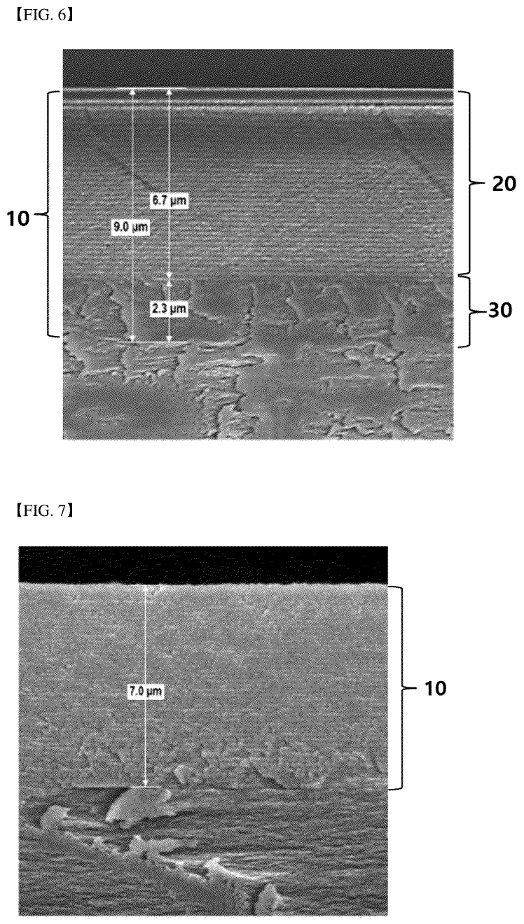

On the other hand, FIG. 5 is a photograph of a cross section of the photopolymer film of Example 1 taken with an SEM. FIG. 6 is a photograph of a cross section of a photopolymer film of Example 2 taken with an SEM. FIG. 7 is a photograph of a cross section of the photopolymer film of Comparative Example 1 taken with an SEM.

### 3. Evaluation of Adhesion (Cross-Cut)

After recording on the recording layer of the photopolymer film of the Examples and Comparative Examples using a laser with a wavelength of 660 nm, a cross-cut test was performed on the recording layer.

Specifically, 100 checkerboard-shaped cuts (10 width×10 height) were made on the recording layer of the photopolymer film so that the width and height were 1 mm each, and peelings was performed twice using a tape (produce name: CT-24, manufacturer: Nichiban). After that, the recording layer and the substrate film were separated, the state of being scratched or peeled was evaluated according to the <Evaluation Criteria>below, and the results are shown in Table 3 below.

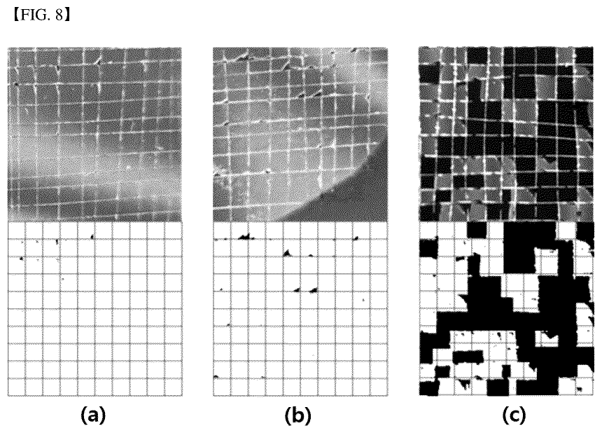

Meanwhile, in FIG. 8, (a) is a photograph of the cross-cut evaluation result of Example 1, (b) is a photograph of the cross-cut evaluation result of Example 2, and (c) is a photograph of the cross-cut evaluation result of Comparative Example 1.

### Evaluation Criteria

5B: The number of remaining spaces without falling off is 100% of the total spaces
4B: The number of remaining spaces without falling off is 95% or more but less than 100% of the total spaces
3B: The number of remaining spaces without falling off is 85% or more but less than 95% of the total spaces
2B: The number of remaining spaces without falling off is 65% or more but less than 85% of the total spaces
1B: The number of remaining spaces without falling off is 35% or more but less than 65% of the total spaces
0B: The number of remaining spaces without falling off is 0% or more but less than 35% of the total spaces

### 4. Evaluation of Heat and Moist Resistance Reliability

After recording on the recording layer of the photopolymer film of the Examples and Comparative Examples using a laser with a wavelength of 660 nm, heat resistance and moist resistance reliability were evaluated.

Specifically, the reflection spectrum of the recording layer of the photopolymer film was measured using a UV-Vis spectrophotometer to confirm the wavelength (2, nm) at which the reflection peak appeared.

Then, to evaluate the heat resistance reliability, the recording layer of the photopolymer film was attached to a glass plate with a BPSA (Barrier pressure-sensitive adhesive) and left at a temperature of 95° C. for 72 hours. After that, the reflection spectrum of the recording layer of the photopolymer film was measured again using a UV-Vis spectrophotometer, and the degree to which the reflection peak had moved was confirmed as the change in wavelength (Δλ, nm), and the results are shown in Table 3 below.

In addition, to evaluate the moist heat reliability, the recording layer of the photopolymer film was attached to a glass plate with BPSA, and was left at a temperature of 85° C. and a humidity of 85% for 72 hours. After that, the reflection spectrum of the recording layer of the photopolymer film was measured again with a UV-Vis spectrophotometer, the degree to which the reflection peak had moved was confirmed as the change in wavelength (Δλ, nm), and the results are shown in Table 3 below.

### 5. Evaluation of Recording Efficiency

After recording on the recording layer of the photopolymer film of the Examples and Comparative Examples using a laser with a wavelength of 660 nm, the recording efficiency was evaluated.

Specifically, the reflection spectrum of the recording layer of the photopolymer film was measured using a UV-Vis spectrophotometer, and the wavelength (2, nm) at which the reflection peak appeared was confirmed to measure the recording efficiency.

TABLE 3

| | | | | Thickness | | | | |
|---|---|---|---|---|---|---|---|---|
| | Maximum | | | ratio of | | | | |
| | reduction | Erosion | Recording | erosion | | Heat | Moist | |
| | rate of | layer | layer | layer to | | resistance | resistance | Recording |
| | band area | thickness | thickness | coating | Cross- | reliability, | reliability, | efficiency |
| | ((μm-1) | ((μm) | (μm) | layer (%) | cut | Δλ (nm) | Δλ (nm) | (%) |
| Example 1 | 0.062 | 4.0 | 5.2 | 43.5 | 4B | 1.0 | 2.0 | 96.1 |
| Example 2 | 0.082 | 2.3 | 6.7 | 25.6 | 3B | 2.5 | 4.5 | 97.5 |
| Example 3 | 0.073 | 2.6 | 5.9 | 30.6 | 4B | 2.0 | 4.5 | 91.5 |
| Example 4 | 0.054 | 3.6 | 5.0 | 41.9 | 5B | 1.0 | 2.0 | 93.8 |
| Example 5 | 0.042 | 4.4 | 4.3 | 50.6 | 5B | 1.5 | 3.5 | 95.5 |
| Example 6 | 0.014 | 5.5 | 3.4 | 61.8 | 4B | 3.0 | 9.5 | 96.0 |
| Example 7 | 0.029 | 7.9 | 5.5 | 59.0 | 4B | 1.5 | 4.5 | 97.1 |
| Example 8 | 0.091 | 2.8 | 10.7 | 20.7 | 3B | 2.5 | 5.0 | 95.6 |
| Comparative | 0.098 | 0.3 | 7.2 | 0.04 | 0B | 4.5 | 13.0 | 98.0 |
| Example 1 | | | | | | | | |
| Comparative | 0.096 | 1.1 | 7.1 | 13.4 | 1B | 3.5 | 11.0 | 97.5 |
| Example 2 | | | | | | | | |
| Comparative | 0.009 | 7.2 | 3.0 | 70.6 | 5B | 0.5 | 1.5 | 68.9 |
| Example 3 | | | | | | | | |

According to Table 3, it was confirmed that in Examples, the maximum reduction rate of band area of 0.010 μm⁻¹ to 0.095 μm⁻¹ is satisfied, an erosion layer of 20.0% to 70.0% is formed relative to the coating layer (erosion layer+recording layer), the adhesion is excellent, and the heat and moist resistance reliability and the recording efficiency are excellent.

On the other hand, it was confirmed that in Comparative Example 1, the erosion layer is barely formed, and the adhesion and the heat and moist resistance reliability are also poor; in Comparative Example 2, the erosion layer is formed to be 13.4% thinner than the coating layer, and the adhesion and the heat and moist resistance reliability are poor; and in Comparative Example 3, the erosion layer is formed too thickly to a thickness of 70.6% relative to the coating layer, and the recording efficiency is poor.

### DESCRIPTION OF SYMBOLS

10: coating layer
20: recording layer
30: erosion layer
40: substrate film

1. A photopolymer film comprising a substrate film and a recording layer,
wherein a graph derived from results of photothermal infrared (PTIR) spectroscopic analysis in a thickness direction from one surface of the recording layer facing the substrate film satisfies the following Equation 1, in which a band area of a carbonyl group (C═O group) peak included in the recording layer is plotted on the Y-axis, and a distance in the thickness direction from one surface of the recording layer facing the substrate film is plotted on the X-axis.
$$0.01 {μm}^{- 1} ≦ Maximum reduction rate of band area ≦ 0.095 {μm}^{- 1} \qquad [ Equation 1 ]$$
in the Equation 1,
the maximum reduction rate of the band area is an absolute value of the minimum value of a y value in the graph obtained by first differentiating the graph.

2. The photopolymer film according to claim 1,
further comprising an erosion layer between the substrate film and the recording layer.

3. The photopolymer film according to claim 2, wherein:
the photopolymer film comprises a coating layer containing the erosion layer and the recording layer, and
a thickness ratio of the erosion layer to the coating layer is 20.0% or more and 70.0% or less.

4. The photopolymer film according to claim 2, wherein:
the erosion layer has a thickness of 1.0 μm or more and 10.0 μm or less.

5. The photopolymer film according to claim 1, wherein:
the substrate film is a cellulose ester-based substrate film, a polyester-based substrate film, a poly(meth)acrylate-based substrate film, a polycarbonate-based substrate film, a cycloolefin-based (COP)-based substrate film, or an acryl-based substrate film.

6. The photopolymer film according to claim 1, wherein:
the substrate film is a triacetyl cellulose (TAC) film.

7. The photopolymer film according to claim 1, wherein:
the recording layer comprises a polymer matrix containing a siloxane-based polymer, and a photoreactive monomer.

8. The photopolymer film according to claim 7, wherein:
the photoreactive monomer and the polymer matrix containing a siloxane-based polymer have a weight ratio of 45:55 to 90:10.

9. The photopolymer film according to claim 2, wherein:
the erosion layer includes a photoreactive monomer.

10. A composition for forming a photopolymer film, comprising a coating solution that includes a polymer matrix containing a siloxane polymer or a precursor thereof, a photoreactive monomer, and an erosion solvent,
wherein a content of the erosion solvent is 25 wt. % or more and 70 wt. % or less with respect to 100 wt. % of the coating solution.

11. The composition for forming a photopolymer film according to claim 10, wherein:
the erosion solvent is at least one selected from the group consisting of a ketone-based solvent, an ester-based solvent, a nitrogen-based compound solvent, a halogenated hydrocarbon-based solvent, and an aromatic hydrocarbon-based solvent.

12. A holographic recording medium comprising the photopolymer film according to claim 1.

13. An optical element comprising the photopolymer film according to claim 1.
